(19) United States
(12) Patent Application Publication
(10) Pub. No.: US 2012/0191540 A1
(43) Pub. Date: Jul. 26, 2012

(54) AUTOMATIC APPLICATION OF TARGETED ADVERTISING IN DATASETS

(75) Inventors: Adam D. Wilson, Seattle, WA (US); Maxim Uritsky, Sammamish, WA (US)

(73) Assignee: MICROSOFT CORPORATION, Redmond, WA (US)

(21) Appl. No.: 13/010,498

(22) Filed: Jan. 20, 2011

(51) Int. Cl. G06Q 30/00

(52) U.S. Cl. 705/14.53; 705/14.55

(57) ABSTRACT

Embodiments are directed to the providing an advertising model for delivering advertisements with data sets and to streaming data sets that include targeted advertising. In an embodiment, an instantiated advertising model receives from a user a query for data. The advertising model is communicatively connected to a data store that includes multiple data sets. The query requests data from one or more of the data sets. The advertising model determines which data sets are to be retrieved based on the query. The advertising model adds targeted advertisements to the determined data sets and sends the determined data sets along with the targeted advertisements to the user.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications may be designed to access and present data to a user. For instance, an application may be designed to access a dataset and automatically arrange the data into a coherent and organized display. The datasets may include large amounts of data saved over multiple years. Providing the data to users may introduce bandwidth, server and other costs.

### BRIEF SUMMARY

Embodiments described herein are directed to the providing an advertising model for delivering advertisements with data sets and to streaming data sets that include targeted advertising. In one embodiment, an instantiated advertising model receives from a user a query for data. The advertising model is communicatively connected to a data store that includes multiple data sets. The query requests data from one or more of the data sets. The advertising model determines which data sets are to be retrieved based on the query. The advertising model adds targeted advertisements to the determined data sets and sends the determined data sets along with the targeted advertisements to the user.

In another embodiment, an instantiated advertising model receives from a user a query for data. The advertising model is communicatively connected to a data store that includes multiple data sets. The query requests data from one or more of the data sets. The advertising model determines which data sets are to be retrieved based on the query. The advertising model determines, based on various user-dependent factors, which advertisements are to be included with the determined data sets and dynamically combines the determined data sets and the determined advertisements while streaming the data to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including providing an advertising model for delivering advertisements with data sets.

FIG. 2 illustrates a flowchart of an example method for providing an advertising model for delivering advertisements with data sets.

FIG. 3 illustrates a flowchart of an example method for streaming data sets that include targeted advertising.

FIG. 4 illustrates an alternative computer architecture for providing an advertising model that delivers advertisements with data sets.

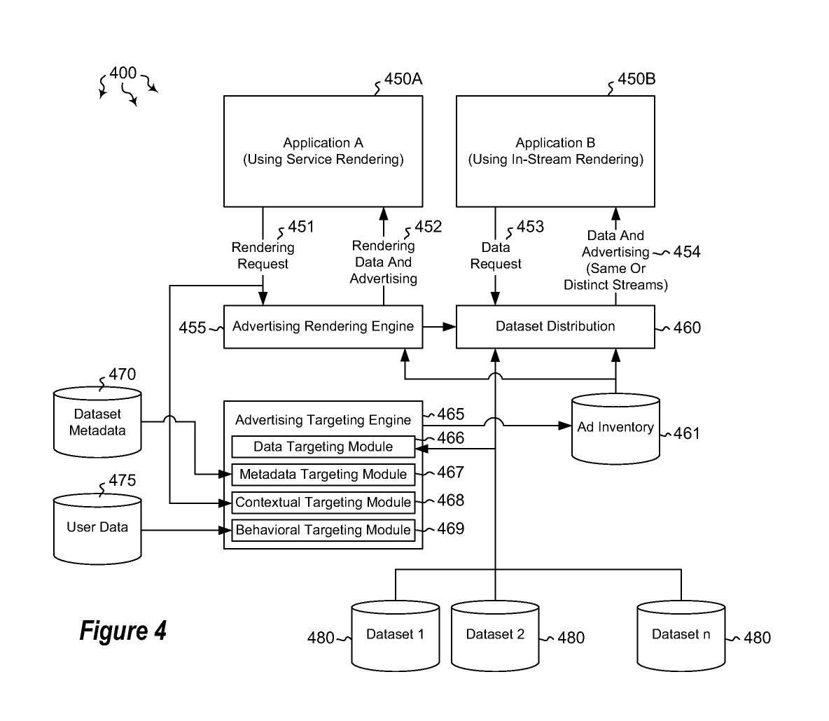

### DETAILED DESCRIPTION

Embodiments described herein are directed to the providing an advertising model for delivering advertisements with data sets and to streaming data sets that include targeted advertising. In one embodiment, an instantiated advertising model receives from a user a query for data. The advertising model is communicatively connected to a data store that includes multiple data sets. The query requests data from one or more of the data sets. The advertising model determines which data sets are to be retrieved based on the query. The advertising model adds targeted advertisements to the determined data sets and sends the determined data sets along with the targeted advertisements to the user.

In another embodiment, an instantiated advertising model receives from a user a query for data. The advertising model is communicatively connected to a data store that includes multiple data sets. The query requests data from one or more of the data sets. The advertising model determines which data sets are to be retrieved based on the query. The advertising model determines, based on various user-dependent factors, which advertisements are to be included with the determined data sets and dynamically combines the determined data sets and the determined advertisements while streaming the data to the user.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks (e.g. cloud computing, cloud services and the like). In a distributed system environment, program modules may be located in both local and remote memory storage devices.

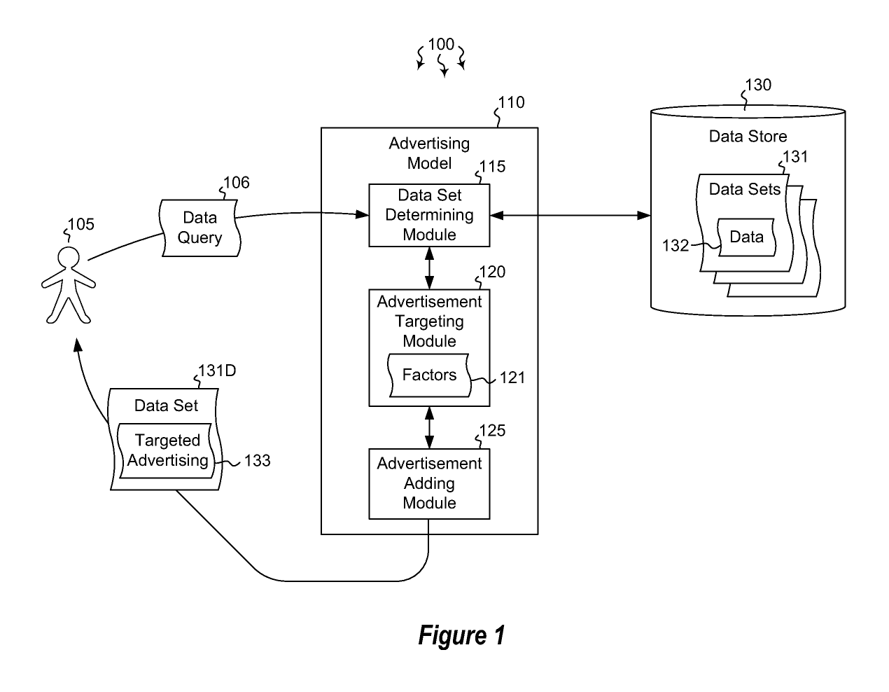

FIG. 1 illustrates a computer architecture 100 in which the principles of the present invention may be employed. Computer architecture 100 includes advertising model 110. The advertising model may be instantiated on a single computer system or on a plurality of computer systems. For instance, in some embodiments, the advertising model may be instantiated on the cloud. The advertising model is configured to receive data queries 106 from users such as user 105. The data queries may request data from a data store 130. The data store may comprise local or remote storage and may likewise be stored on a single computer system or on a plurality of computer systems (e.g. on a storage area network (SAN) or on the cloud). The data requested by the user may be part of a data set 131. Each data set may include multiple portions of data 132. In some cases, the data may represent large portions of data stored over years of time. This data may be provided to the user, along with some form of advertising.

The data set determining module 115 of advertising model 110 may be configured to receive user data requests and determine which data set(s) is/are to be retrieved from the data store. The advertisement targeting module 120 may determine which advertising is most relevant to the user based on one or more factors 121 including the type of data requested by the user, metadata information about the requested data, previous usage information associated with the user, contextual information about the context in which the data is to be shown, and other factors. The advertisement adding module 125 may add the advertising determined to be the most relevant or appropriate for the user to the retrieved data set. Accordingly, the determined data set 131D that was retrieved from the data store may be sent to the user 105, along with the targeted advertising 133 added to the data by advertisement adding module 125.

In some embodiments, the advertising model 110 may be designed to treat datasets as advertising inventory. The advertizing inventory may include advertisement locations identifying where the advertisements are to be placed on the screen. Advertisements may be targeted against this inventory using a variety of techniques and rendered with the dataset 131 using a variety of techniques. Content providers that publish datasets can choose to enable ad-supported pricing models and control how advertising is delivered with their datasets. Such pricing models may include cost per impression, cost per click and cost per action. In a cost per impression model, content providers may charge advertisers for each time an ad is viewed or loaded in a web page (i.e. an impression). In a cost per click model, content providers may charge advertisers for each time an ad is clicked. In a cost per action model, content providers may charge advertisers for each time an ad is clicked and action is taken based on that click. Other pricing models may be used, and the examples provided should not be read as limiting the type of pricing model(s) that may be used.

Various targeting techniques may be used for determining which advertisements are shown with which data. One type of targeting technique may be: data targeting. In data targeting, the contents of the dataset being retrieved by the application or end-user determine which advertisements are shown. A second targeting technique is metadata targeting. In metadata targeting, information about the dataset, content provider, or additional non-data information determines which advertisements are shown. A third targeting technique is behavioral targeting. In behavioral targeting, previous usage of the application or by the end-user across multiple datasets and content providers determine which advertisements are shown. A fourth targeting technique is contextual targeting. In contextual targeting, information about the context in which the data is shown, including other facets of the application or web site, determines which advertisements are shown. As will be understood by one skilled in the art, other types of targeting techniques may be used in addition to or as an alternative to those listed.

Various different methods for delivering advertisements may be used. In-stream delivery may deliver advertising as part of the dataset, either as separate rows or separate columns, or both. The end-user or application shows advertising along with the data. The data and advertising may be rendered by a service. The end-user or application developer instructs that service what data they wish to view and the service renders the data alongside the advertising. This method allows the service to guarantee that advertising is actually shown and is not circumvented by the application developer or end-user. Additionally or alternatively, the data and advertising may be rendered by an application. The advertising may be distributed alongside the dataset to the application where the application renders the advertising in the application, potentially rendering it differently depending on the application.

A content provider may be presented with various options for how to monetize their dataset(s) using advertising. The content provider may configure various information such as the floor price of advertising per transaction or per other unit of their dataset, restrictions on the kind of advertising that can be shown with their data, and other settings.

Additionally, an application developer can choose to support advertising-supported datasets in their application using several models. Which models are available to an application developer may depend on the degree of trust the service owner has in the developer, whether an application has been certified and other factors. In one model for the application developer, advertising is returned as part of the data, either as separate rows or as additional columns. In this model, the application developer processes and displays this extra advertising just as any other data.

Another model involves the application developer writing a declarative representation of how the data should be displayed to an end-user, as well as possible interactions with that data. This declarative representation may include hints from the developer about where advertising could be displayed in the application (if not, the service could determine this automatically). The service uses this declarative representation along with a query from the application about what data should be shown to retrieve the data and advertising and render it using the declarative representation, outputting an image, markup, or other representation of the rendered application, which is returned to the application or directly to the end-user for display.

Yet another model returns advertisements along with the data, leaving it up to the application to render the advertisements in the application in a suitable location. In this model in particular, but also for the other two models above, it is possible that the application developer is incented to properly display advertising through a system where they are compensated for displaying advertising or other metrics derived from this (clicks on advertising or other downstream actions, such as e-commerce purchases).

In determining what advertising to display, the advertising model 110 may use various factors. The query issued by an application or end-user 105 may be analyzed to determine which data and advertising are appropriate to display. Also, the metadata about the data retrieved can be used, such as the title of the dataset, various marketing descriptions, the content provider information, and also other data crawled from other systems or web pages and associated with the content provider or dataset. Still further, the data itself that is returned can be analyzed to determine relevant advertising. For example, a search against a point of interest dataset for restaurants in zip code 98101 might return one restaurant that corresponds to a unit of ad inventory (from the owner of that restaurant). In this case, the data itself could be replaced with an advertisement in-stream, that provides better images or a longer description than a normal restaurant entry would provide. The context in which the data is displayed may also be used to target ads. This might be the web page on which the data is embedded, profile information in the service about the application developer, or other information.

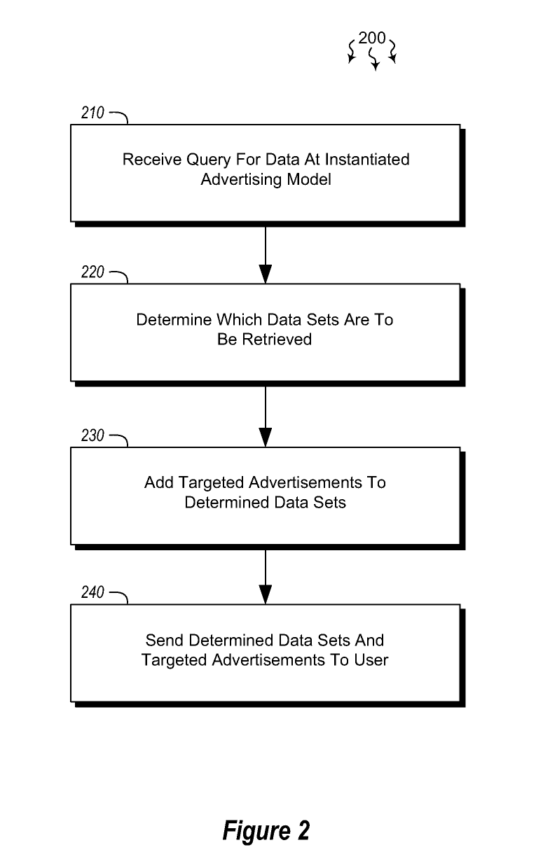

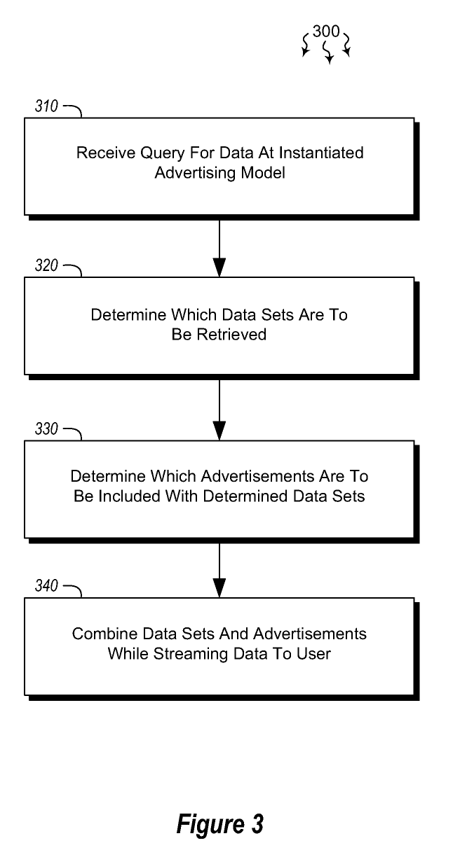

In some cases, since the user is known, various behavioral techniques can be used to determine appropriate targeted advertising. The previous actions of the user against the data sets 131 of data store 130 can target which ads are shown. Also, the unique user identity with a service can be correlated with the user identity in other services and other advertising platforms, enabling the ads served through the current service to be targeted based on the user's action in other services or other sites. In some embodiments, any two or more of the above targeting methods may be combined or used together. In this manner, targeted advertising may be combined with data sets and displayed to a user. The concepts described above will be described in greater detail below with regard to methods 200 and 300 of FIGS. 2 and 3, below.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for providing an advertising model for delivering advertisements with data sets. The method 200 will now be described with frequent reference to the components and data of environment 100.

Method 200 includes an act of receiving from a user a query for data at an instantiated advertising model, wherein the advertising model is communicatively connected to a data store comprising a plurality of data sets, wherein the query is requesting data from one or more of the data sets (act 210). For example, data set determining module 115 of advertising model 110 may receive data query 106 from user 105. The advertising model may be configured to transfer data to and receive data from data store 130. The data store stores data sets, each with their own data. The user, a software application or other entity may request substantially any number of data sets from data store 130.

Method 200 includes an act of the advertising model determining which data sets are to be retrieved based on the query (act 220). For example, data set determining module 115 of advertising model 110 may determine which data sets 131 are to be retrieved from the data store based on the received data query 106. The data may be retrieved and temporarily stored at the advertising model so that advertisements can be added to the data set(s) before being sent to the user or application.

Method 200 further includes an act of the advertising model adding one or more targeted advertisements to the determined data sets (act 230). For example, advertisement adding module 120 may add those ads determined by advertisement targeting module 120 to be most relevant to the data retrieved by module 115. The targeted advertisements may be targeted to a user or application based on one or more user-customizable factors 121. These factors may be chosen by a content provider (e.g. that provides data sets 131) or by another user. Each factor may be customizable and may include various settings which are dynamically adjustable.

In some cases, the user-customizable factors 121 may include the contents of the data set, so that the advertisements are targeted to the user based on the data of the data set. Accordingly, in such cases, ads related to the data requested may be shown to the user. For instance, if the user requested upcoming sports matches for a particular team, ads related to the venues of the upcoming matches, which is contained in the dataset, may be shown to the user. In other cases, the user-customizable factors may include metadata information about the data set that was retrieved, so that the advertisements are targeted to the user based on the metadata information about the data set. For instance, information about the data set may include content provider information, information about the size of the data set, the data set's origin, the data's creator, reporting tools that can be used with the data, or other information. Each portion of metadata information may be used to further target a particular advertisement to a particular user.

In some cases, the user-customizable factors may include user behavior, so that the advertisements are targeted to the user based on the user's prior usage data. If the user has interacted with the advertising model or with a particular data set in the past, this usage data may be used to target specific ads for the user. In other cases, the user-customizable factors may include data context, so that the advertisements are targeted to the user based on the current context in which the data is being shown. Thus, the advertising model may determine how the data is being shown or is going to be shown, and may choose specific advertisements accordingly.

In some embodiments, advertisers or content providers may elect to promoted certain advertisements in relation to the other advertisements. The advertiser may pay the data's owner to do so. The advertisement may be promoted in a variety of manners, including increasing the size, placement, color scheme or other feature to make the ad stand out in relation to the other advertisements.

As explained above, the targeted advertisements incorporated into the data sets are billed to the advertiser in a cost per impression manner. In this scenario, the advertiser would pay the content owner or creator each time an ad is shown along with the data. In some cases, the data provider or host may act as a middle man or agent that facilitates payment for the ads. In the cost per click scenario, the advertiser would pay the content owner or creator each time an advertisement is clicked or otherwise selected. In the cost per action scenario, the advertiser would pay the content owner or creator each time an advertisement results in a sale of the item or service being advertised. Other billing methods may be use, and the above billing methods may be used in combination with each other, as well as with other billing methods.

Method 200 includes an act of the advertising model sending the determined data sets along with the one or more targeted advertisements to the user (act 240). For example, advertising model 110 may send the determined data set 131D coupled with targeted ads 133 to the user or application. In some cases, the ads are added as data sets separate from the determined data sets. Thus, in such cases, the data may be separate from the data that is part of the data set, and is provided in different rows or columns. When received at the user's computer system or at the application, the application or another service may render the data and ads. In cases where a service renders the data and ads, the service can guarantee to the advertiser that the ads are being displayed and are not being stripped out or blocked. In some cases, hints may be added to the data sets to indicate where the advertisements are to be displayed in the service's rendering.

FIG. 3 illustrates a flowchart of a method 300 for streaming data sets that include targeted advertising. The method 300 will now be described with frequent reference to the components and data of environment 400.

Method 300 includes an act of receiving a query from a user for data at an instantiated advertising model, wherein the advertising model is communicatively connected to a data store comprising a plurality of data sets, wherein the query is requesting data from one or more of the data sets (act 310). For example, a user or an application (e.g. application B (450B)) may send a data request 453 to data set distribution module 460. Data set distribution module 460 may be configured to access data sets 480 to provide the requested data.

Method 300 includes an act of the advertising model determining which data sets are to be retrieved based on the query (act 320). For example, data set distribution module 460 may determine which data sets are to be retrieved based on query 453. Using this determination, the distribution module may retrieve the appropriate data sets.

Method 300 includes an act of the advertising model determining, based on one or more user-customizable factors, which advertisements are to be included with the determined data sets (act 330). For example, advertising targeting engine 465 may determine, based on factors included in modules 466-469, which advertisements from ad inventory 461 are to be included with the retrieved data sets. The data targeting module 466 may be used to target ads based on the content of the retrieved data. The metadata targeting module 467 may target ads based on metadata information 470 associated with the retrieved data sets. The contextual targeting module 468 may target ads based on the context in which the ads will be displayed (e.g. in application A (450A) using service rendering, or in application B (450B) using in-stream rendering). The behavioral targeting module 469 may target ads based on the user's or the application's prior use of the retrieved data sets or other data sets, or other user data 475.

Method 300 includes an act of the advertising model dynamically combining the determined data sets and the determined advertisements while streaming the data to the user (act 340). For example, advertising rendering engine 455 may dynamically combine the retrieved data sets 480 with the targeted ads and send the combination 452 to the application. In one embodiment, application A may implement service rendering. The application may send a rendering request 451, where the advertising rendering engine will send the rendered data and advertising 452 to the application for display. In another embodiment, application B may send a data request 453 and receive the data and ads 454 in the same or in different streams.

In some cases, the advertisements (e.g. from ad inventory 461) are combined with the data sets 480 as columns of information to be displayed alongside the data sets. In other cases, the advertisements are combined with the data sets as rows of information to be displayed alongside the data sets. The user may be able to indicate to a service how the data sets and advertising are to be rendered and the service may then render the data sets and advertising according to the user's indication. The service may provide a guarantee to the advertiser that the advertisements are being displayed along with the data sets, and not being blocked or filtered out. Software applications such as A and B (450A and 450B) may render the data sets and targeted advertisements according to various software application layout constraints. In this manner, the data sets and ads can be displayed in a different manner in each software application.

Accordingly, systems, methods and computer program products are shown which provide an advertising model for delivering targeted advertisements with data sets. Moreover, systems, methods and computer program products are provided which stream data sets that include targeted advertising to users and/or applications.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including at least one processor and a memory, in a computer networking environment including a plurality of computing systems, a computer-implemented method for providing an advertising model for delivering advertisements with data sets, the method comprising:
an act of receiving from a user a query for data at an instantiated advertising model, wherein the advertising model is communicatively connected to a data store comprising a plurality of data sets, wherein the query is requesting data from one or more of the data sets;
an act of the advertising model determining which data sets are to be retrieved based on the query;
an act of the advertising model adding one or more targeted advertisements to the determined data sets; and
an act of the advertising model sending the determined data sets along with the one or more targeted advertisements to the user.

2. The method of claim 1, wherein the targeted advertisements are targeted to the user based on one or more user-customizable factors.

3. The method of claim 2, wherein at least one of the user-customizable factors includes the contents of the data set, such that the advertisements are targeted to the user based on the data of the data set.

4. The method of claim 2, wherein at least one of the user-customizable factors includes metadata information about the data set, such that the advertisements are targeted to the user based on the metadata information about the data set.

5. The method of claim 2, wherein at least one of the user-customizable factors includes user behavior, such that the advertisements are targeted to the user based on the user's prior usage data.

6. The method of claim 2, wherein at least one of the user-customizable factors includes data context, such that the advertisements are targeted to the user based on the current context in which the data is being shown.

7. The method of claim 1, wherein advertisements are promoted in relation to the other advertisements based on one or more factors.

8. The method of claim 1, wherein the advertisements are added as data sets separate from the determined data sets.

9. The method of claim 1, wherein the determined data sets and the targeted advertisements are rendered by a service.

10. The method of claim 9, wherein one or more hints are added to the data sets indicating where the advertisements are to be displayed in the service's rendering.

11. The method of claim 1, wherein the targeted advertisements incorporated into the data sets are billed in a cost per impression manner.

12. The method of claim 1, wherein the targeted advertisements incorporated into the data sets are billed in a cost per click manner.

13. The method of claim 1, wherein the targeted advertisements incorporated into the data sets are billed in a cost per action manner.

14. A computer program product for implementing a method for streaming data sets that include targeted advertising, the computer program product comprising one or more computer-readable storage media having stored thereon computer-executable instructions that, when executed by one or more processors of the computing system, cause the computing system to perform the method, the method comprising:
an act of receiving a query from a user for data at an instantiated advertising model, wherein the advertising model is communicatively connected to a data store comprising a plurality of data sets, wherein the query is requesting data from one or more of the data sets;
an act of the advertising model determining which data sets are to be retrieved based on the query;
an act of the advertising model determining, based on one or more user-customizable factors, which advertisements are to be included with the determined data sets; and
an act of the advertising model dynamically combining the determined data sets and the determined advertisements while streaming the data to the user.

15. The computer program product of claim 14, wherein the advertisements are combined with the data sets as columns of information to be displayed alongside the data sets.

16. The computer program product of claim 14, wherein the advertisements are combined with the data sets as rows of information to be displayed alongside the data sets.

17. The computer program product of claim 14, wherein the user indicates to a service how the data sets and advertising are to be rendered and the service renders the data sets and advertising accordingly.

18. The computer program product of claim 17, wherein the service provides a guarantee to the advertiser that the advertisements are being displayed along with the data sets.

19. The computer program product of claim 14, wherein a software application renders the data sets and targeted advertisements according to one or more software application layout constraints.

20. A computer system comprising the following:
one or more processors;
system memory;
one or more computer-readable storage media having stored thereon computer-executable instructions that, when executed by the one or more processors, causes the computing system to perform a method for providing an advertising model for delivering advertisements with data sets, the method comprising the following:
an act of receiving a query from a user for data at an instantiated advertising model, wherein the advertising model is communicatively connected to a data store comprising a plurality of data sets, wherein the query is requesting data from one or more of the data sets;
an act of the advertising model determining which data sets are to be retrieved based on the query;
an act of the advertising model determining which advertisements are to be added to the determined data sets based on one or more of the following factors: the contents of the determined data set, metadata information about the determined data set, previous usage information about the user and contextual information about the context in which the data is to be shown;
an act of the advertising model adding the determined targeted advertisements to the determined data sets; and
an act of the advertising model sending the determined data sets along with the one or more targeted advertisements to the user.
